(19) United States
(12) Patent Application Publication
(10) Pub. No.: US 2008/0193605 A1
(43) Pub. Date: Aug. 14, 2008

(54) NUTRITIONALLY ENHANCED NUT PRODUCT

(76) Inventors: Robert G. Gonzalez, Naperville, IL (US); Leonard E. Stark, Naperville, IL (US)

Correspondence Address: BARNES & THORNBURG LLP, P.O. BOX 2786, CHICAGO, IL, 60690-2786, US

(21) Appl. No.: 12/027,874

(22) Filed: Feb. 7, 2008

Related U.S. Application Data
(60) Provisional application No. 60/900,122, filed on Feb. 8, 2007.

(51) Int. Cl. A23L 1/38; A23L 1/36

(52) U.S. Cl. 426/87; 426/633

(57) ABSTRACT

Methods and compositions are described to prepare an enhanced nut butter product by replacing a portion of nut oil in the formulation of an unenhanced butter with one or more oils, such that the enhanced nut butter product has, when compared to the unenhanced nut butter: a higher level of monounsaturated fatty acids reported to have health benefits; a higher level of long chain omega-3 fatty acids (EPA/DHA) reported to have health benefits; a lower overall fat content; similar or improved texture and taste; the ability to have FDA health claims on its label as a result of the added oils; and having oils in its formulation that are preferred by consumers. Embodiments include peanut butter and almond butter.

This application claims priority from co-pending U.S. Ser. No. 60/900,122 filed Feb. 8, 2007, incorporated by reference in its entirety herein.

### BACKGROUND

Methods and compositions are described to produce an enhanced, nut butter product, by substituting an oil that is not typically contained in the unenhanced nut butter product, for a portion of the oil typically contained in the unenhanced products, such that the resulting nut butter product has a significant content of the substituting oil recognized to provide health benefits, a reduced level of total “fat” while maintaining taste and spreadability, the ability to be labeled with an FDA approved health claim, and a significant content of the substituting oil which is desired by consumers. Nut butters include peanut butter and almond butter.

It is widely recognized that the diets of many Americans and persons in other developed countries contain fat at levels significantly in excess of the levels that are recommended for optimal health and nutrition. In addition, it is widely thought that the types of fats that are now commonly a component of highly processed foods and modem agriculture practices, such as saturated fats, trans fats and omega-6 fats, have led to an increase in mortality and morbidity related to the excess intake of these fats. And, while there have been numerous efforts to educate and influence consumers to reduce their intake of fat and to modify the types of fats consumed, it is clear that it is difficult to change consumer's eating habits. One of the difficulties in changing consumer eating habits is thought to be related to taste and texture of alternative healthier products. Specifically, reduced fat products have often been criticized as having less taste or poor mouthfeel when compared to the full fat versions. Also, there are some fats that are thought to have health benefits, such as fish oil, that have taste and stability issues that make them hard to formulate and process. The result is that consumers continue to eat foods for which they like the taste and texture and do not significantly modify the types or amounts of fats consumed.

For many years it has been recognized that populations that consume a higher proportion of their diet from food groups that have been characterized as the Mediterranean Diet have a lower incidence of heart disease. This is paradoxical because these same people consume relatively higher levels of fat. There are several components of the Mediterranean Diet that, along with fruit and vegetable consumption, are thought to have some effect on its apparent health benefits: olive oil, fish and red wine. Olive oil is though to be a key factor. Unlike the high amount of animal fats typical to the American diet, olive oil which is consumed at relatively high levels in the Mediterranean Diet, lowers cholesterol levels in the blood. It is also reported to lower blood sugar levels and blood pressure. Research indicates olive oil prevents peptic ulcers, is effective in treatment of peptic ulcer disease, and may be a factor in preventing cancer. Olive oil is rather unique in that it has very high levels of monounsaturated fat and it can also contain high levels of antioxidants. In fact olive oil has an FDA approved health claim for reducing the risk of heart disease when it replaces a similar amount of saturated fat in the diet and does not increase the total calories. Another oil that is high in monounsaturated fats is canola oil, which also has an FDA approved health claim.

The long chain omega-3 fatty acids, docosahexaenoic acid (commonly known as DHA) and eicosapentaenoic acid (commonly known as EPA) are recognized as providing important health benefits including such things as: facilitating fetal and infant brain development; maintaining cardiovascular health; reducing the risk of secondary events in patients with cardiovascular disease; and improving blood lipid profiles in hyperlipodemic patients. There is also a body of developing evidence that they may be helpful in other areas such as: depression, cognitive impairment, attention deficit (hyperactivity) disorder, and macular degeneration. The American Heart Association recommends that adults without documented coronary heart disease attempt to increase their intake of DHA and EPA by eating at least 2 servings of fatty fish per week. Based on the USDA Food and Nutrient Database for Dietary Studies this would be equivalent to a minimum of 2 g per week or 286 mg/d (USDA Food and Nutrient Database for Dietary Studies.) For patients with documented coronary heart disease they recommend 1000 mg/d of EPA and DHA per day. And, for patients with high triglycerides, they recommend 2000-4000 mg/d under a physician's supervision.

The International Society for the Study of Fatty Acids and Lipids (ISSFAL) is an international scientific society established in 1991, of more than 500 members from more than 40 countries. ISSFAL members are scientists, medical professionals, educators, administrators, communicators and others with an interest in the health effects of dietary fats, oils and lipids. ISSFAL is the foremost International Scientific Society dealing exclusively with the health impact of dietary lipids. The ISSFAL recommends that adults consume a minimum of 500 g/d of EPA and DHA to maintain cardiac health. Unfortunately it is apparent that the American diet is woefully short of consuming the levels of EPA and DHA that are recommended. Based on the USDA's “What We Eat in America”, NHANES 2003-04 it is estimated that half of the adult population consumes less then 30 mg of EPA and DHA.

Nut butters, in particular, peanut butter, are popular, widely consumed foods that have several nutritional characteristics that are attractive such as: high protein content, fiber, niacin and potassium. However, peanut butter also has a relatively high fat content of approximately 50%, and peanut oil includes omega-6 fatty acids, which the majority of Americans already consume in excess of the amounts required. The U.S. Department of Agriculture, Agricultural Research Service (2007 USDA National Nutrient Database for Standard Reference, Release 20. Nutrient Data Laboratory Home Page, http://www.ars.usda.gov/ba/bhnrc/ndl reports) that a typical serving of peanut butter (32 g) contains: 50.39% fat, 25.09% protein, 3.15% ash, 1.81% water and 19.56% carbohydrates (by difference.) This source also indicates that a serving of peanut butter contains 0.649% potassium and 0.013403% niacin. Thus, the appeal of peanut butter as a good source of protein, fiber and potassium is offset by its high fat value.

Peanut butter is conventionally prepared from shelled peanut kernels roasted at about 170° C. and then cooled to about 30° C. The roasted peanuts are then blanched (i.e. the skins and nibs are removed), and the blanched kernels are split into halves. The blanched, split peanuts are ground, and optional ingredients, for example, seasonings, mono and diglycerides and stabilizers, such as hydrogenated vegetable oil or the more saturated fraction of palm oil, are added to the ground nuts. All the ingredients are thoroughly mixed and then finely ground. For a crunchy peanut butter, peanut granules are also added to the mixture. The resulting mixture is then cooled and packed in containers.

Color and flavor are largely a function of peanut varieties, roasting and seasonings. The consistency recognized as characteristic of conventional peanut butter products, however, derives chiefly from the free oil resulting from the grinding step and the incorporation of stabilizers. During grinding, the peanut kernal is transformed into a semi-liquid state to form a product having a pasty and spreadable consistency. This occurs largely as a result of particulation of the peanut kernal with concurrent rupture of its oil (or fat) cells. Sufficient oil is generally released (although in some instances, supplementary amounts may be added) to form a continuous oil phase which will disperse the finely ground kernal particles.

In time, however, part of the oil separates from the product and forms a separate layer on the top of the peanut butter and a rigid crumbly mass underneath. This is often referred to as “natural” or “old fashioned” peanut butter. This tendency of peanut butter to separate on standing can be overcome to a significant extent by the use of stabilizers. Stabilizers are generally highly hydrogenated vegetable oils, solid fractions of oils such as palm oil, or other emulsifiers such as mono- and diglycerides. Stabilized peanut butters typically require a crystallization step, using a scraped wall heat exchanger that produces a matrix of fine fat crystals that essentially “lock up” the liquid oil/peanut solid mixture to prevent the oil from coalescing and separating. These products are also referred to as “no-stir”.

The Food and Drug Administration has promulgated a standard of identity for “Peanut Butter” that states that the peanut ingredients must comprise at least 90% of the weight of the finished product, (21 CFR Section 164.150) and limiting the non-peanut ingredients to certain seasoning and stabilizing ingredients. The Food and Drug Administration has promulgated a standard of identity for “Peanut Spread” for spreadable peanut products that do not meet 21 CFR164.150 but that are nutritionally equivalent to peanut butter. The Food and Drug Administration has promulgated a standard of identity for “Imitation Peanut Butter” for spreadable peanut products that do not meet 21 CFR164.150 and that are nutritionally inferior to peanut butter.

“Crunchy” peanut butters contain substantial added quantities of peanut granules. “Natural” or “Old-Fashioned” peanut butter generally designates products that have not added a stabilizer and in which the oil tends to separate. “Non-Stir”, “No-Stir”, or “Stabilized” peanut butter generally designates products that do not have an added stabilizer and in which the oil tends not to separate. “All Natural” is also a term that refers to products made with all of the ingredients coming from sources considered to be natural, a debatable category. The term “peanut butter product” as used herein is intended to include peanut butters, peanut spreads, and imitation peanut butters, whether creamy, crunchy, old-fashioned, natural, no-stir, stabilized, all natural, or including ingredients not considered natural.

There have been efforts made to improve the healthfulness of peanut butter products. These have been primarily in the areas of reducing the fat level and substituting fats with reduced and non-caloric fats and fat substitutes. in peanut butter products. In order to reduce the high fat value, attempts have been made to replace fat with various materials. This has included non- or reduced caloric fat replacers such as olestra or medium chain tryglcerides. It has included various forms of starches, gums, fibers, and other non-caloric bulking agents with various levels of hydration. Such attempts, however, have met with limited success, because the resulting products have typically suffered from some deficiency such as off taste, lack of peanut taste, mouth feel, viscosity, spreadability, regulatory approval, anal leakage and the like.

Attempts have been made to reduce fats in peanut butter by mechanical extrusion and through the utilization of pressure filters. However, the resulting products suffered from taste, texture, viscosity and mouthfeel issues as a result of the reduced fat content.

A combination of partially defatted (2.61% and 16% remaining oil) ground roasted peanuts (peanut flour), medium chain triglcyerides, and optionally peanut oil, can result in a reduced calorie peanut butter based on the effect of the medium chain triglycerides (primarily C8 and C10 fatty acids) on viscosity, allowing a lower level of oil to be used, and the lower calorie content per gram of the C8 and C10 fatty acids. However, medium chain triglycerides are not eligible for health claims, or recognized as desirable by consumers.

A combination of partially defatted ground roasted peanuts (peanut flour), peanut oil, ground roasted peanuts and maltodextrin can result in a reduced fat peanut butter product. This product may be eligible for reduced fat claims, but not for health claims. Taste and texture are suspect.

Flax oil has been added to peanut butter to justify a claim of omega-3 content. However, the omega-3's in flax are C18's and the technical evidence indicates that they are converted to the metabolically important EPA and DHA only to a very limited extent.

There has also been peanut butter products produced where long chain omega-3 fatty acids, EPA and DHA, have been added. However, while some long chain omega-3 containing foods are eligible to be labeled with an FDA approved health claim, current regulations prevent adding these health claims, explicitly or even implicitly through product naming or graphical representation, to the peanut butter products because they have too high of a fat level. There are also high oleic acid peanuts that have recently been introduced to the agricultural community that would provide a higher level of monounsaturates in a peanut butter then currently available peanut butter. However, the availability of this variety of peanut is limited and to date significant data has not been reported showing whether or not high oleic peanuts would have any health benefit, and the FDA has not been petitioned to approve any health claim for such a product.

Almond butter is a similar product to peanut butter in that is a made by grinding of the almond nut. Similar to peanuts, whole almonds can have a health claim. However, almond products such as almond butters cannot have a health claim because there is too high a fat content per serving.

Although some efforts have succeeded in making some nut butter products nutritionally enhanced, problems with taste, texture, spreadability, and the limits on communicating the benefits to consumers have limited their success.

### SUMMARY

Methods and compositions are described for replacing a portion of fats and oils in food products with fats and oils reported to have greater health benefits. A reduced fat nut butter composition containing 30-40% oil is combined with olive oil or canola oil to provide a 42-52% oil containing product. Almonds and peanuts are examples of suitable nuts.

The reduced fat nut butter composition containing 30-40% oil can be a combination of peanut flour and/or reduced fat peanut paste, and optionally additional peanut paste. Peanut paste, reduced fat peanut paste, or peanut flour can be manufactured from high oleic peanuts. Other ingredients such as flavors, seasoning, sweeteners, stabilizers, omega-3 (EPA/DHA) are optionally added and do not substantially affect the quality, health benefits, taste and texture of the nut butter. Suitable sweeteners include sugar, molasses, and evaporated cane juice. Fiber may be added-preferably between 9-16% of the formulation (excluding crunchy nuts.) Embodiments include nut butters, in particular, enhanced peanut butter and enhanced almond butter.

An enhanced peanut butter product consists essentially of peanut flour, and/or reduced fat peanut paste, and one or more non-peanut ingredients, for example, oils with reported health benefits such that the enhanced peanut butter product, when compared with its unenhanced form has the following attributes:

(a) a higher percentage of non-peanut oil with a high percentage of monounsaturated fatty acids;

(b) reduced total fat content while maintaining taste and spreadability;

(c) the ability to have FDA health claims on its label (optional); and

(d) a higher percentage of non-peanut oils that are preferred by consumers (optional), and other ingredients that do not substantially affect the overall quality, health benefits, taste and texture of an enhanced nut butter.

Non-peanut ingredients are oils such as olive oil and canola oil that are recognized to provide a higher percentage of healthier fatty acids as a result of their monounsaturated fatty acid content.

Through the addition of an added non-peanut ingredient, a health claim can be made for the enhanced peanut butter product that cannot be made on the unenhanced peanut butter product. Also, the label of the product can contain a health claim related to heart health, more specifically prevention of heart disease. Furthermore, an added non-peanut ingredient provides an attribute that is preferred by consumers.

An example of an enhanced nut butter product has a 2.6% relative reduction of fat content, excluding peanut granules added, with no significant increase in viscosity and without loss of peanut flavor.

An enhanced peanut butter product can also include the addition of from 1 mg to 1000 mg of long chain omega-3 fatty acids (EPA/DHA) per 32 g serving.

Nut granules may be added to make a “crunchy” peanut butter, preferably around 10% of a finished formulation, while still providing the desired levels of olive oil, canola oil or omega-3 fatty acids.

A stabilized peanut butter was manufactured without the use of a processing step such as a scraped walled heat exchanger that results in a rapid cooling and formation of fine crystals.

A stabilized peanut butter was manufactured with the addition of an encapsulated source of long chain omega-3 fatty acids.

### DEFINITIONS

Fat—Esters of glycerol and fatty acids.

Oil—Fat that is liquid at room temperature.

Fatty acids—formed by hydrolysis of ester linkages in fat or oil, remove glycerol.

Nut Paste—ground roasted nuts typically with approximately 47-53% fat content.

Nut Flour—partially defatted ground roasted nuts of a powder form typically containing less then 30% fat.

Reduced Fat Nut Paste—partially defatted ground roasted nuts of a paste form typically containing more than about 30% fat and less then 47% fat.

### BRIEF DESCRIPTION OF THE DRAWINGS

FIG. 1 is a graphical representation of the results of a consumer preference study.

FIG. 2 is an embodiment of a label for an enhanced peanut butter.

### DETAILED DESCRIPTION

### Enhanced Peanut Butter

Representative formulations of enhanced peanut butter include at least a non-peanut (e.g., olive, canola) oil high in monounsaturated fats or that enables FDA recognized health claims and preferably that is preferred by consumers over peanut oil, peanut flour and/or reduced fat peanut paste, and optionally additional peanut paste. These ingredients are combined in sufficient amounts, and mixed to provide a final product that, excluding nut granules for crunchy products, has a total fat content (peanut oil and olive oil) of ˜47.5% which is slightly lower then typical peanut butter which is ˜50% fat. The final product has a protein content similar to “typical” peanut butter of ˜20% to 30% by weight.

Products were made with 6 g of olive oil per 32 g serving. This is an amount sufficient to qualify for health claims. Canola oil is used at 4.75 g/serving as this is an amount sufficient to qualify for health claims. Greater or lesser amounts of these oils is also used. Other oils that may become eligible for FDA health claims in the formulated peanut butter products is used. Light roasted and medium roasted peanut flours with about 12% peanut oil were used. Peanut flour with higher oil content is used. A reduced fat peanut paste (30-40% fat) is used in place of the combination of peanut flour and peanut paste. Combinations of olive and canola oils are also suitable.

One method to make an enhanced peanut butter-like product combines olive oil with peanut flour, encapsulated fish oil, seasoning, stabilizers and peanut paste.

Currently, while many ingredients, including EPA/DHA, have qualified health claims, most of these approved claims are not allowed in high fat foods, such as peanut butter. However, olive oil and canola oil are exceptions. They can be in high fat foods providing other conditions are met. Formulations exemplified herein meet these conditions.

The FDA has approved two qualified health claims for vegetable oils high in monounsaturated fatty acids: olive oil and low erucic acid rapeseed (LEAR). Consumer research has shown that olive oil is preferred by consumers, however, both are suitable.

The monounsaturated level of the olive oils used ranged from 50% to 80%. The FDA has based their health claim on an olive oil that is 74% monounsaturated. A minimum of 70% monounsaturated and average of 74% or higher is preferred.

The following forms of olive oil were used: extra virgin, refined, refined pomace, blend of virgin and refined, and blend of virgin and pomace. Using only virgin olive oil is also suitable.

Based on data provided by the United States Department of Agriculture, olive oil contains approximately 14% Saturated fatty acids, 73 Monounsaturated fatty acids, and 10% Polyunsaturated fatty acids (U.S. Department of Agriculture, Agricultural Research Service. 20047 USDA Nutrient Database for Standard Reference, Release 20 Nutrient Data Laboratory Home Page, http://www.ars.usda.gov/ba/bhnrc/ndl). FDA Docket No. 2006Q-0091.)

Canola oil, also known as low erucic acid rapeseed (LEAR) oil, is a fully refined, bleached, and deodorized edible oil obtained from certain varieties of Brassica napus or B. campestris of the family Cruciferae. The plant varieties are those producing oil-bearing seeds with a low erucic acid content [21 CFR 184.1555(c)(1)].

Canola oil contains approximately 91.4% of monounsaturated and polyunsaturated fatty acids [2007 USDA National Nutrient Database for Standard Reference, Release 20].

Two sources of long chain omega-3 fatty acids were used: Ropufa® Omega-3 from DSM Parsippany, N.J. and MEG-3® Omega-3 from Ocean Nutrition® Dartmouth, Nova Scotia Canada. Both of these are powder products produced from fish oils and provide a rich source of the long chain fatty acids DHA and EPA. EPA/DHA contents of 32 mg, 100 mg and 320 mg per 32 g serving were formulated. There is an algal source of EPA and DHA (Martek) that is used. Other omega-3 products that are encapsulated or other powder forms that provide oxidative protection to the fish oil and limit any fishy taste or odor are suitable. Fish oil in its oil form can have objectionable taste and odor at time0 and develop over time a fishy odor as a result of oxidation. Several unencapsulated oil samples from companies (Denomega and Ocean Nutrition) have low taste and odor at time0. Such unencapsulated oils free of fishy taste and odor at time0 is used in stabilized products where the oil is trapped within the peanut butter product matrix or in “old fashioned” peanut butter products packed in an inert atmosphere and stored under refrigerated conditions after opening.

Final products were prepared that optionally included salt, evaporated cane juice, brown sugar, nut granules, fiber, and palm oil stabilizers. Other ingredients such as mono- and diglycerides, other stabilizers, other seasonings and flavorings, and/or other sweeteners may also be added similar to their use in peanut butter that is in the art. These ingredients are added but do not substantially affect the quality, health benefits, taste or texture of an enhanced nut butter.

Enhanced peanut butter products were made by replacing a portion of the peanut oil with several types of olive oil, and two types of long chain omega-3 fatty acids.

A summary of various embodiments follows:
1. Replacing a portion of fats and oils in unenhanced peanut butter formulations with olive oil, e.g., with 6 g/serving of olive oil; or canola oil, e.g., with 4.75 g/serving of canola oil.
2. Replacing a portion of fats and oils in unenhanced peanut butter formulations with olive oil or canola oil, replacing an additional portion of fats in unenhanced peanut butter formulations with long chain omega-3 fats and oils, e.g., with fish oil long chain omega-3 fats and oils; with algal oil containing long chain omega-3 fats and oils; or with plant derived oil containing long chain omega-3 fats and oils.
3. Adding fiber to 1 or 2 above
4. A peanut butter product with a reduced fat content was made by replacing a portion of an unenhanced peanut butter product with a combination of peanut flour and olive oil or canola oil.

A formulation for an enhanced peanut butter product includes:
Olive Oil 18.75% (6 g/serving to meet FDA requirement for health claims) [e.g., 3% low end is a practical amount to claim “content” with consumers, upper limit is determined by costs and fat content of peanut flour, e.g., 54%] OR
Canola Oil 14.84% (4.75 g/serving to meet FDA requirement for health claims) [e.g., 3% low end is a practical amount to claim “content” with consumers, e.g., 54% upper limit is determined by costs and fat content of peanut flour]; MEG-3 Powder 0-18.8% [0 and 0.67-2.08% were used to provide 0 and 32-100 mg omega-3 per 32 g serving];
Salt 0-2% to taste [e.g. 0 and 0.9%];
Sweetener 0-5% to taste (includes sugar, molasses, evaporated cane juice) [e.g. 0, 3 and 4%];
Peanut Butter Stabilizer 0-4% [e.g. 0 and 3%];
Remaining portion, with the combination of all ingredients and the remaining portion having a fat content of 42-54% total fat, consisting of peanut flour and/or reduced fat peanut paste, and optionally additional peanut paste

A method of making peanut butter or the grinding of peanuts (normal and/or partially defatted), either with olive or canola oil or followed by the addition of olive oil or canola oil, adding and mixing a source of long chain omega-3, is described. Commercially available peanut flour (either 12 or 28% fat) has enough fat removed to be suitable. It behaves as a dry ingredient which is necessary for its normal use. Essentially, it has too much fat removed for purposes of the disclosure and therefore both the flour and the paste (˜50%) are combined to get to the desired fat level in the finished product (˜47.5% peanut and olive or canola oil.) Reduced fat peanut paste can replace the combination of peanut flour and peanut paste. A reduced fat peanut paste is made by utilizing various processes including mechanical expeller, pressure filtration, centrifugation and decanting. The method may optionally add other typical ingredients used in peanut butter such as salt, sweeteners, stabilizers, pieces of peanuts; and may add other ingredients such as artificial sweeteners, no or reduced caloric sweeteners, fat replacers, fiber, bulking agents.

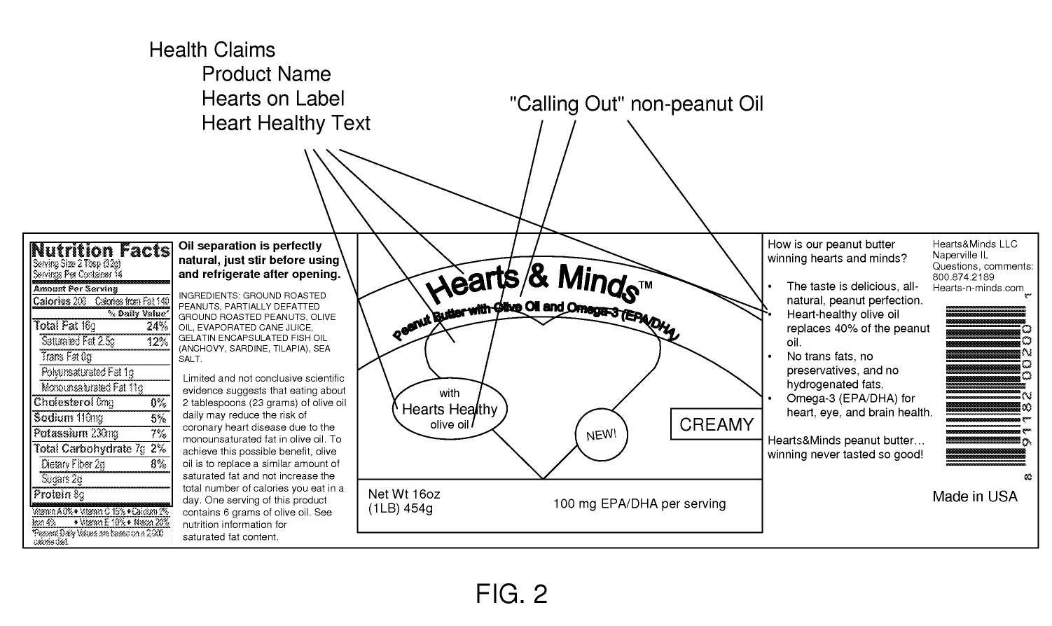

A method of influencing consumers to purchase an enhanced peanut butter product include labeling the enhanced peanut butter product with an FDA approved health claim, such a claim based on the replacement of peanut oil with olive oil or canola oil. [FIG. 2]

A method of influencing consumers to purchase an enhanced peanut butter product includes, in addition to labeling required in an ingredient statement, labeling the enhanced peanut butter product in such a way that “calls out” or calls attention to olive oil or canola oil as a component of the enhanced peanut butter product[FIG. 2]

Roasted peanut taste is a preferred attribute for peanut butter products for consumers. Samples of enhanced peanut butter products described herein were evaluated by six panel members trained and experienced in peanut butter flavor analysis (JLA Laboratories, Edenton N.C.). The strength of Roasted Peanut Taste was rated on a 0-10 scale (a truncated Universal Spectrum Scale). The Universal Scale allows a panelist to evaluate all attributes therefore eliminating the need for specified product scales. The control which was used as reference for panelists was Roasted Ground Peanut Paste, evaluated by Sensory Spectrum. Typically a desirable roasted peanut may have Roasted Peanut Intensities (RP) score at a 5-8; free of any off flavors.

Enhanced products made with light roasted peanut flour had better taste then products made with medium roasted peanut flour as shown in Table 1.

TABLE 1

| Sample | RP* |
|---|---|
| Olive Oil, Omega-3 Enhanced Peanut Butter with Medium Roast | 4.2 |
| Flour | |
| Olive Oil, Omega-3 Enhanced Peanut Butter with 50/50 blend | 5.0 |
| of Light and Medium Roast Flour | |
| Olive Oil, Omega-3 Enhanced Peanut Butter with Light Roast | 6.3 |
| Flour | |

*RP = Roasted Peanut Score

It was further discovered that Olive Oil, Omega-3 Enhanced Peanut Butter made with Light Roast Peanut Flour had superior roasted peanut taste then commercially available samples of “old fashioned” peanut butter as shown in Table 2.

TABLE 2

| | RP |
|---|---|
| Peanut Butter Products | |
| Olive Oil, Omega-3 Enhanced Peanut | 5.7 |
| Butter with Light Roast Flour A | |
| Olive Oil, Omega-3 Enhanced Peanut | 6.9 |
| Butter with Light Roast Flour B | |
| Olive Oil, Omega-3 Enhanced Peanut | 5.7 |
| Butter with Light Roast Flour C | |
| Olive Oil, Omega-3 Enhanced Peanut | 6.2 |
| Butter with Light Roast Flour D | |
| Olive Oil, Omega-3 Enhanced Peanut | 6.6 |
| Butter with Light Roast Flour E | |
| Olive Oil, Omega-3 Enhanced Peanut | 6.2 |
| Butter with Light Roast Flour F | |
| Olive Oil, Omega-3 Enhanced Peanut | 6.6 |
| Butter with Light Roast Flour G | |
| Olive Oil, Omega-3 Enhanced Peanut | 6.4 |
| Butter with Light Roast Flour H | |
| Competitive Products | |
| M1 | 3.8 |
| A1 | 5.3 |
| SC1 | 4.8 |
| 3′ | 4.6 |
| M2 | 4.4 |
| AM | 5.6 |
| SC2 | 5.4 |

### Enhanced Almond Butter

Many nut and nut products are eligible for qualified health claims provided they have less then 13 g of fat per serving. Most nut butters have about 16 g fat per serving so health claims are not allowed. If olive or canola is used to replace a portion of nut fat, the product may have health claims. For example if, in a 32 g serving of almond butter, 6 g of olive oil or 4.75 g of canola oil were substituted for an equivalent amount of almond oil, the resulting product would have an oil recognized for its health benefits and would be eligible for a health claim on its label.

### EXAMPLES

### Example 1

### Olive Oil Peanut Butters

Olive oil peanut butters are prepared as described below. The peanut paste is commercially available product containing roasted peanuts, sugar, salt hydrogenated vegetable oil, molasses, mono- and diglycerides (JIF creamy peanut butter.) The olive oil is commercially available light refined olive oil (Dominicks Light Refined Olive Oil, blend of refined olive oil and virgin olive oil.) The peanut flours used are commercially available partially defatted, light roasted peanut flours labeled 12% fat or 28% fat (Golden Peanut Company, 12% Product Code 521271-Light Roast, and 28% Product Code 522857-Light Roast.) The olive oil peanut butters have the following compositions:

WEIGHT %

| INGREDIENT | Sample1 | Sample2 |
|---|---|---|
| Olive Oil | 18.75 | 18.75 |
| Peanut Flour 12% Oil | 24.67 | None |
| Peanut Flour 28% Oil | None | 42.60 |
| Peanut Paste (50% Oil) | 56.58 | 36.65 |

Olive oil and peanut flour are combined and mixed in 8 oz container until homogenous mixture, approx 30 seconds with moderate stirring. Peanut Paste was added and mixed until homogenous, approx 30 seconds with moderate stirring. The olive oil peanut butter products, containing 50% fat, have consistency, texture, and flavor typical of peanut butter, and contain 6 g of olive oil per 32 g serving.

### Example 2

### Normal and Reduced Fat Olive Oil Peanut Butters with Long Chain Omega-3 Fatty Acids (EPA/DHA)

Olive oil peanut butter compositions are prepared with long chain omega-3 fatty acids (EPA and DHA) and varying ratios of peanut flour and peanut paste as described below. The peanut paste is commercially available ground roasted peanuts (Fat Content 52.64%, Hunter L Roast Color 45.24, Fine Grind.) The olive oil is commercially available light refined olive oil (Crisco Imported Light Olive Oil, blend of refined olive oil and virgin olive oil.) The peanut flour used is commercially available partially defatted, light roasted peanut flour 12% fat (Golden Peanut Company, Product Code 521271-Light Roast, analyzed as 12.7% fat) The long chain omega-3 is microencapsulated fish oil containing 15% total EPA and DHA (Ocean Nutrition, MEG-3 Omega-3.) The olive oil peanut butters with long chain omega-3 (EPA/DHA) have the following compositions:

| | WEIGHT % | |
|---|---|---|
| | Sample | Sample |
| | Reduced Fat | Normal Fat |
| INGREDIENT | R-1106-1 | R-1106-2 |
| Olive Oil | 18.75 | 18.75 |
| Peanut Flour 12% | 39.10 | 29.10 |
| Microencapsulated Fish Oil (60% fat) | 2.08 | 2.08 |
| Peanut Paste (52.64% fat) | 40.06 | 50.06 |

Peanut paste, peanut flour and olive oil are combined in bowl and mixed in Kitchen Aide® Mixer until thoroughly mixed. Microencapsulated fish oil is added and mixed until evenly dispersed. Product was filled into 12 oz plastic jars and capped.

Reduced fat olive oil peanut butter with omega-3 product has a fat content of 46.05% fat. Normal olive oil peanut butter with omega-3 has a fat content of 50.05% fat. Both products have roasted peanut taste typical of peanut butter. The texture of the normal fat product (50.05% fat) is somewhat less viscous than typical natural peanut butter. The texture of the reduced fat product (46.05% fat) is similar to typical stabilized peanut butter. Both samples have 6 g of olive oil per 32 mg serving and 100 mg of omega-3 (EPA and DHA) per 32 mg serving.

### Example 3

### Evaluating Effect of Peanut Flour Type on Taste in Reduced Fat Olive Oil Peanut Butters with Long Chain Omega-3 Fatty Acids

Reduced Fat Olive oil peanut butter with long chain omega-3 compositions were prepared with varying ratios of two types of peanut flour (light roast and dark roast.) The peanut paste is commercially available product ground roasted peanuts (Fat Content 52.29%, Hunter L Roast Color 49.93, Fine Grind.) The olive oil is commercially available light refined olive oil (Crisco Imported Light Olive Oil, blend of refined olive oil and virgin olive oil.) The peanut flour (light roast) used is commercially available partially defatted, light roasted peanut flour 12% fat (Golden Peanut Company, Product Code 521271-Light Roast, analyzed as 12.7% fat) The peanut flour (medium roast) used is commercially available partially defatted, medium roasted peanut flour 12% fat (Golden Peanut Company, Product Code 521264-Medium Roast, analyzed as 12.29% fat) The long chain omega-3 is microencapsulated fish oil containing 15% total EPA and DHA (Ocean Nutrition, MEG-3 Omega-3.) The olive oil peanut butters with long chain omega-3 (EPA/DHA) have the following compositions:

| | WEIGHT % | | |
|---|---|---|---|
| | Sample | Sample | Sample |
| | 50:50 Blend | Light Roast | Medium Roast |
| INGREDIENT | R-1106-4 | R-1106-5 | R-1106-6 |
| Olive Oil | 18.75 | 18.75 | 18.75 |
| Peanut Flour Light Roast (12.7% fat) | 17.55 | 35.10 | none |
| Peanut Flour Medium Roast (12.29% fat) | 17.55 | none | 35.10 |
| Microencapsulated Fish Oil (60% fat) | 2.08 | 2.08 | 2.08 |
| Peanut Paste (52.29% fat) | 44.00 | 44.00 | 44.00 |

Peanut Paste, peanut flour(s) and olive oil are combined in bowl and mixed in Kitchen Aide® Mixer until thoroughly mixed. Microencapsulated fish oil is added and mixed until evenly dispersed. Product is filled into 8 oz plastic jars and capped.

The fat content of the formulations ranges from 47.32% to 47.46% which is reduced from the 50% typically in peanut butter. The textures of the three formulations are typical of stabilized peanut butter. The three samples have 6 g of olive oil per 32 mg serving and 100 mg of omega-3 (EPA and DHA) per 32 mg serving. Sample R-1106-5 (light roast peanut flour) had Roasted Peanut flavor score higher than Sample R-1106-4 (blend of light and medium roast flour) which was higher than Sample R-1106-6 (medium roast peanut flour).

### Example 4

### Evaluating Different Levels and Sources of Long Chain Omega-3

Different levels and sources of omega-3 were evaluated in peanut butter. The peanut paste is a commercially available product containing roasted peanuts, sugar, salt hydrogenated vegetable oil, molasses, mono- and diglycerides (JIF creamy peanut butter.) One source of long chain omega-3 is microencapsulated fish oil containing 15% total EPA and DHA (Ocean Nutrition, MEG-3 Omega-3.) A second source of long chain omega-3 is powdered fish oil containing 10% total EPA and DHA (DSM Nutritional Products, ROPUFA 10 N-3 Food Powder, 10% EPA/DHA). Peanut butters with long chain omega-3 (EPA/DHA) had the following compositions:

| | WEIGHT % | | | |
|---|---|---|---|---|
| | ROPUFA | | MEG-3 | |
| | 32 mg | ROPUFA | 32 mg | MEG-3 |
| | EPA/DHA per 32 g | 320 mg EPA/DHA | EPA/DHA per 32 g | 320 mg EPA/DHA |
| INGREDIENT | serving | per 32 g serving | serving | per 32 g serving |
| Ropufa 10 N-3 | 1.00 | 10.00 | None | none |
| MEG-3 Powder | None | None | 0.67 | 6.70 |
| Peanut Butter | 99.00 | 90.00 | 99.33 | 93.30 |

The omega-3 powder is combined and mixed with peanut butter in 8 oz containers until a homogenous mixture, approximately 30 seconds with moderate stirring. The containers are covered and sealed with aluminum foil and stored at room temperature. Peanut butter products with long chain omega-3 contained between 32 mg and 320 mg of EPA/DHA per 32 mg serving, had taste and texture typical of stabilized peanut butter immediately after formulation, and had no fishy taste or odor 12 months after formulation.

### Example 5

### Evaluating Different Sources of Olive Oil in Olive Oil Peanut Butter Formulations

Olive oil peanut butter compositions were prepared with different types of olive oil. The peanut paste is commercially available product (Maranatha, Natural Peanut Butter, ground-roasted peanuts.) Three types of olive oil are used: refined olive oil (Safeway Select Light Olive oil, blend of refined olive oil and virgin olive oil); extra virgin olive oil (S. Coop. de Labradores de Alcorisa, Alcorci virgin olive oil); and pomace olive oil (Portofino Foods, pomace olive oil.) The peanut flour used is commercially available partially defatted, light roasted peanut flour 12% fat (Golden Peanut Company, Product Code 521271-Light Roast.) The long chain omega-3 is microencapsulated fish oil containing 15% total EPA and DHA (Ocean Nutrition, MEG-3 Omega-3.) Sugar is powdered baking sugar. The olive oil peanut butters had the following compositions:

| | WEIGHT % | | |
|---|---|---|---|
| | Sample | Sample | Sample |
| | Refined Olive | Extra Virgin | Pomace Olive |
| INGREDIENT | Oil | Olive Oil | oil |
| Olive Oil | 18.74 | 18.76 | 18.76 |
| Peanut Flour 12% Light | 21.94 | 20.70 | 24.71 |
| Roast | | | |
| Microencapsulated Fish | 2.08 | 2.09 | None |
| Oil | | | |
| Sugar | None | 5.00 | None |
| Peanut Paste | 57.23 | 53.46 | 56.53 |

Dry ingredients were first blended, followed by the addition of olive oil. Combined ingredients were mixed until homogeneous texture and appearance, approximately 30 seconds with moderate stirring. Peanut Paste was added and mixed until a homogeneous appearance. All samples have taste and texture typical of natural peanut butters. All samples contained 6 g of olive oil per 32 mg serving. Refined olive oil and extra virgin olive oil samples have 100 mg omega-3 (EPA and DHA) per 32 mg serving.

### Example 6

### Olive Oil Peanut Butters with Additional Fiber

Olive oil peanut butter compositions were prepared with different levels (3 g and 5 g per serving) of additional fiber. The fiber is inulin (Cargill Oliggo-Fiber® XL Inulin, dietary fiber extracted from chicory roots.) The peanut paste is commercially available product (Maranatha, Natural Peanut Butter, ground-roasted peanuts.) Two types of olive oil were used: refined olive oil (Safeway Select Light Olive oil, blend of refined olive oil and virgin olive oil); and pomace olive oil (Portofino Foods, pomace olive oil.) The peanut flour used is commercially available partially defatted, light roasted peanut flour 12% fat (Golden Peanut Company, Product Code 521271-Light Roast.) The long chain omega-3 is microencapsulated fish oil containing 15% total EPA and DHA (Ocean Nutrition, MEG-3 Omega-3.) Sugar is powdered baking sugar. The olive oil peanut butters had the following compositions:

| | WEIGHT % | |
|---|---|---|
| | Sample | Sample |
| | 3 g Fiber | 5 g Fiber |
| INGREDIENT | added per Serving | added per Serving |
| Olive Oil Refined | 18.75 | None |
| Olive Oil Pomace | None | 18.75 |
| Fiber (Inulin) | 9.38 | 15.63 |
| Peanut Flour (12% fat) | 20.00 | 16.72 |
| Microencapsulated Fish Oil | 2.09 | 2.09 |
| (60% fat) | | |
| Sugar | 5.00 | 4.38 |
| Peanut Paste (50% fat) | 44.78 | 42.43 |

Dry ingredients were first blended, followed by the addition of olive oil. Combined ingredients are mixed until a homogeneous texture and appearance, approximately 30 seconds with moderate stirring. Peanut Paste was added and mixed until homogeneous appearance. All samples had taste and texture similar to natural peanut butters. All samples contained 6 g of olive oil per 32 mg serving and 100 mg omega-3 (EPA and DHA) per 32 mg serving. The sample with 3 g of fiber added per 32 mg serving had a fat content of 44.79%. The sample with 5 g of fiber added per 32 mg serving had a fat content of 43.23%.

### Example 7

### Sweetened and Salted Peanut Butter

Sweetened and salted olive oil peanut butter with long chain omega-3 compositions were prepared. The peanut paste is commercially available fine grind roasted peanuts. The olive oil is commercially available light refined olive oil. The peanut flour used is commercially available partially defatted, light roasted peanut flour 12% fat (Golden Peanut Company, Product Code 521271-Light Roast.) The long chain omega-3 is microencapsulated fish oil containing 15% total EPA and DHA (Ocean Nutrition, MEG-3 Omega-3.) Two sweeteners are used: evaporated cane juice (Florida Crystal, Powdered Evaporated Cane Juice); and brown sugar (Food Lion Dark Brown Sugar.) Salt is commercially available fine salt. The olive oil peanut butters had the following compositions:

| | WEIGHT % | | |
|---|---|---|---|
| | | Evaporated Cane | Brown Sugar and |
| INGREDIENT | Salted | Juice and Salt | Salt |
| Peanut Paste | 47.93% | 49.19% | 49.19% |
| Peanut Flour | 30.24% | 24.98% | 24.98% |
| Olive Oil | 18.75% | 18.75% | 18.75% |
| Salt | 1.00% | 1.00% | 1.00% |
| Evaporated Cane Juice | None | 4.00% | None |
| Brown Sugar | None | None | 4.00% |
| Microencapsulated Fish | 2.08% | 2.08% | 2.08% |
| Oil | | | |

Using a Kitchen Aid Mixer, the peanut paste was mixed with peanut flour and olive oil until thoroughly mixed, followed by mixing in the salt and/or sugar, followed by mixing in the Meg-3 as the final ingredient in all formulations. Jars were filled. All samples contain 6 g of olive oil per 32 mg serving and 100 mg omega-3 (EPA and DHA) per 32 mg serving. The salt sample has taste and texture typical of salted natural peanut butter. The two sweetened samples have taste and texture of typical salted and sweetened peanut butters.

### Example 8

### Crunchy Peanut Butter

A crunchy olive oil peanut butter with long chain omega-3 composition is prepared. Peanuts are blanched, roasted peanuts (Virginia medium runner variety, Hunter L color 48.3, containing 51% fat.) The olive oil is commercially available light refined olive oil. The peanut flour used is commercially available partially defatted, light roasted peanut flour 12% fat (Golden Peanut Company, Product Code 521271-Light Roast.) The long chain omega-3 is microencapsulated fish oil containing 15% total EPA and DHA (Ocean Nutrition, MEG-3 Omega-3.) The sweetener is evaporated cane juice (Florida Crystal, Powdered Evaporated Cane Juice). Nut granules are commercially available nut granules (51% Fat, Hunter L roast color 47.7, Medium Profile.) Salt is commercially available fine salt. The crunchy olive oil peanut butter has the following composition:

| INGREDIENT | WEIGHT % |
|---|---|
| Peanuts | 40.7% |
| Peanut Flour | 24.4% |
| Olive Oil | 18.8% |
| Salt | 1.0% |
| Sweetener | 3.0% |
| Nut Granules | 10.0% |
| Microencapsulated Fish Oil | 2.1% |

Peanuts are ground using the Robot Coupe® grinder/mixer to a medium grind. The peanut flour, olive oil, salt and sugar are added and ground in the Robot Coupe grinder/mixer to a fine grind. The resulting temperature is 130-140° F. The microencapsulated fish oil is added and mixed until evenly dispersed. The product is transferred to a bowl, the peanut granules are added and hand mixed until evenly dispersed. The bowl of product is then placed in a vacuum chamber to de-aerate the final product. Bowl is then placed in ice bath, stirring constantly, until temperature reached 100-105° F. Jars are then filled. Crunchy olive oil peanut butter has taste and texture typical of crunchy natural peanut butters.

### Example 9

### Stabilized Olive Oil Peanut Butter

A stabilized olive oil peanut butter with long chain omega-3 composition was prepared. Peanuts are blanched, roasted peanuts (Virginia medium runner variety, Hunter L color 48.3, containing 51% fat.) The olive oil is commercially available light refined olive oil. The peanut flour used is commercially available partially defatted, light roasted peanut flour 12% fat (Golden Peanut Company, Product Code 521271-Light Roast.) The long chain omega-3 is microencapsulated fish oil containing 15% total EPA and DHA (Ocean Nutrition, MEG-3 Omega-3.) The sweetener is evaporated cane juice (Florida Crystal, Powdered Evaporated Cane Juice). Nut granules are commercially available nut granules (51% Fat, Hunter L roast color 47.7, Medium Profile.) Salt is commercially available fine salt. The stabilizer is a palm fruit fraction (Loders Croklaan Revel A, non-hydrogenated palm oil.) The stabilized olive oil peanut butter has the following composition:

| INGREDIENT | WEIGHT % |
|---|---|
| Peanuts | 43.3% |
| Peanut Flour | 28.8% |
| Olive Oil | 18.8% |
| Salt | 1.0% |
| Sweetener | 3.0% |
| Stabilizer | 3.0% |
| Microencapsulated Fish Oil | 2.1% |

Peanuts are ground using the Robot Coupe grinder/mixer to a medium grind. The peanut flour, olive oil, salt and sugar are added and ground in the Robot Coupe grinder/mixer to a fine grind. The resulting temperature is approximately 150-160 F. The melted stabilizer is added to the mixture and mixed to evenly disperse. The microencapsulated fish oil is added and mixed until evenly dispersed. The product is transferred to a bowl and placed in a vacuum chamber to de-aerate the final product. Bowl is then placed in ice bath, stirring constantly, until temperature reaches 95 F. Jars are then filled. Stabilized olive oil peanut butter has taste and texture typical of stabilized peanut butters. After 8 weeks there is no sign of oil separation and the surface has an opaque appearance typical of stabilized peanut butter.

### Example 10

### Canola Oil Peanut Butter

A canola oil peanut butter includes as ingredients:
(a) 3-44% unhydrogenated canola oil;
(b) 0 mg to 1000 mg long chain omega-3 fatty acids (EPA/DHA) per 32 g serving;
(c) salt 0-2% to taste;
(d) sweetener 0-5% to taste;
(e) peanut butter stabilizer 0-4%;
(f) peanut granules 0-20%; and
(g) a remaining portion, with the combination of all ingredients and the remaining portion having a fat content of 42-54% total fat, consisting of peanut flour and/or reduced fat peanut paste and optionally peanut paste.

### Example 11

### Consumer Peanut Butter Preferences

A Discrete Choice Analysis was conducted to evaluate the relative attractiveness of several different values of several different variables in a nut butter. A sample of 402 grocery shoppers, with household incomes over $50,000/yr, aged 18-65, and that had significant influence over the type of nut butter purchased were exposed to 12 different “sets” of three product choices, one set at a time, and asked to identify which choice was preferred. On the odd number of choice sets they were then asked a follow-up question as to whether they would actually buy the preferred choices in place of their current brand. Each set of product choices included three different brand names (Healthy Delight Foods, Competitive Name A and Competitive Name B) where specific attributes for each brand were altered in such a way to expose the respondents to sufficient different sets of choices to allow statistical analysis. Attributes, other than brand name that were analyzed were: three different Omega-3 Claims: (1) contains omega-3 (DHA-EPA) with 32 mg per serving, (2) contains omega-3 (DHA-EPA) with 100 mg per serving; or (3) blank as control; three different oil claims with canola oil (1) replacing ⅓ of the peanut oil, (2) with olive oil replacing ⅓ of the peanut oil, or (3) Blank as control; eight different Health Claims (1) helps children focus, (2) helps prevent heart disease, (3) helps in children's brain development, (4) helps achieve healthy aging, (5) helps prevent cognitive decline in aging, (6) healthy choice for all family, members, (7) helps in providing eye health, or (8) blank as control and six differ Prices per 16 oz ($3.99, $4.99, $5.99, $6.99, $7.99, or $8.99.) The purchase intent data was combined with respondents' indications of volume of peanut butter consumed to determine the contribution to purchase intent of the different values of the different variables.

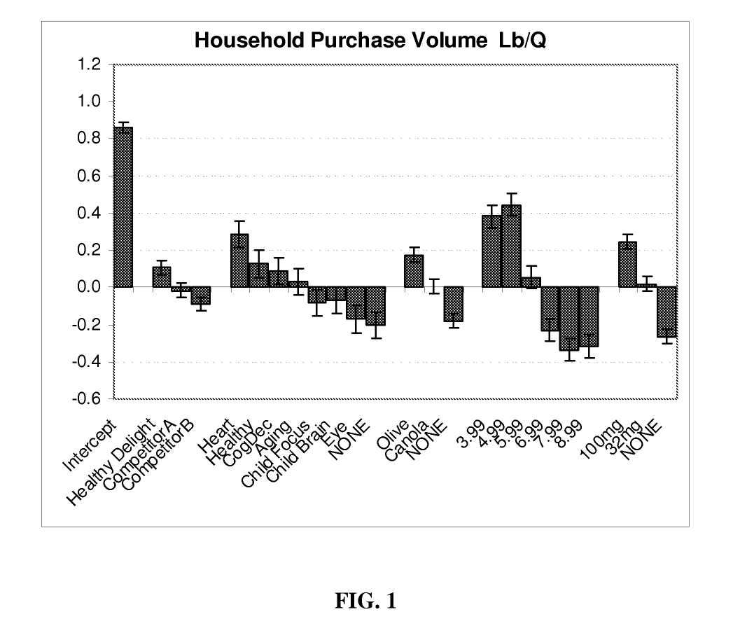

FIG. 1 shows the contribution of each of the variables for the different attributes to the average expected pounds per quarter that a household would purchase (lb/Q)a. The Y axis is the expected pounds per quarter that a household would purchase for the different values of the different attributes. The X axis is the variables included in the attributes. For example a product with: Brand=Healthy Delight, Claim=Heart, Oil=Olive, Omega-3=100, Price=7.99, would have an average expected purchase volume per household of 1.33 pounds per quarter (0.858+0.106+0.284+0.176+0.245−0.335). Factors calculated using ANOVA analysis of variance (XLSTAT).

The results of this consumer research were that, on average, an enhanced peanut butter product with an attribute claiming “olive oil replacing ⅓ of the peanut oil” was preferred over an enhanced peanut butter product with an attribute claiming “canola oil replacing ⅓ of the peanut oil,” which was preferred over a peanut butter product not making any claim regarding replacing peanut oil.

The results of this consumer research were that an enhanced peanut butter product with an attribute claiming “Helps prevent heart disease” was preferred over one claiming “Healthy choice for all family members”, which was preferred over one claiming “Helps prevent cognitive decline in aging”, which was preferred over one claiming “Helps achieve healthy aging,” which was preferred over one claiming “Helps children focus”, which was preferred over one claiming “Helps in children's brain development”, which was preferred over one claiming “Helps in providing eye health,” which was preferred over a peanut butter product making no health claim.

### Example 12

### Enhanced Peanut Butter

An enhanced peanut butter includes as ingredients:
(a) 3-44% unhydrogenated oil (1-14 g/serving) selected from the group consisting of canola or olive oil;
(b) 0-1000 mg long chain omega-3 fatty acids (EPA/DHA) per 32 g serving;
(c) salt 0-2% to taste;
(d) sweetener 0-5% to taste;
(e) stabilizer 0-4%; and
(f) a remaining portion, with the combination of all ingredients and the remaining portion having a fat content of 42-54% total fat, consisting of peanut flour and/or reduced fat peanut paste, and optionally additional peanut paste

### Example 13

### Olive Oil Almond Butter or Canola Oil Almond Butter

An enhanced almond butter includes as ingredients:
(a) 3-44% unhydrogenated oil (1-14 g/serving) selected from the group consisting of canola or olive oil;
(b) 0 to 1000 mg long chain omega-3 fatty acids (EPA/DHA) per 32 g serving;
(c) salt 0-2% to taste;
(d) sweetener 0-5% to taste;
(e) peanut butter stabilizer 0-4%; and
(f) a remaining portion, with the combination of all ingredients and the remaining portion having a fat content of 42-54% total fat, of reduced fat almond paste.

### Example 14

### Enhanced Almond Butter

An enhanced almond butter is produced in a similar manner to the peanut butter examples. A reduced fat almond paste containing approximately 38.5% fat is made by using commercially available mechanical expelling equipment to remove fat before or after the roasting of the almonds. One part of this is then combined with 0.23 parts of olive oil to result in an olive oil almond butter containing at least 6 g of olive oil per 32 g serving. Alternatively, a reduced fat almond paste containing approximately 41.3% fat is made by using commercially available mechanical expelling equipment to remove fat before or after the roasting of the almonds. One part of this is then combined with 0.17 parts of canola oil to result in a canola oil almond butter containing at least 4.75 g of olive oil per 32 g serving. Such almond butter products also have long chain omega-3 (EPA/DHA) sources added or flavors, seasoning, or stabilizers added as desired for taste and texture. Finished products contain approximately 48.7 percent oil (almond, olive or canola, long chain omega-3.)

1. An enhanced nut butter product comprising a non-nut oil that is beneficial to health and an ingredient selected from the group consisting of nut flour and reduced fat nut paste.

2. The enhanced nut butter product of claim 1, wherein the non-nut oil is beneficial to health because it provides a higher percentage of healthier fatty acids as a result of its monounsaturated fatty acid content.

3. The enhanced nut butter product of claim 2, wherein the non-nut oil ingredient is olive oil.

4. The enhanced nut butter product of claim 2, wherein the non-nut oil is canola oil.

5. The enhanced nut butter product of claim 1, wherein the non-nut oil is preferred by consumers.

6. The enhanced nut butter product of claim 1, wherein the nut is a peanut.

7. The enhanced nut butter product of claim 1, wherein the nut is an almond.

8. The enhanced nut butter product of claim 1, comprising a 2-5% relative reduction of fat content in the product, compared to an unenhanced nut butter product excluding any nut granules added.

9. The enhanced nut butter of claim 8 with no significant increase of viscosity compared to the unenhanced nut butter.

10. The enhanced nut butter product of claim 1, further comprising 1 to 1000 mg of long chain omega-3 fatty acids (EPA/DHA) per 32 g serving.

11. The enhanced nut butter product of claim 1, further consisting of an ingredient selected from the group consisting of sweetener, stabilizer, nut granules, flavors, seasonings and combinations thereof.

12. An enhanced peanut butter product comprising:
(a) 3-44% unhydrogenated oil selected from the group consisting of canola or olive oil;
(b) 0-1000 mg long chain omega-3 fatty acids (EPA/DHA) per 32 g serving;
(c) salt 0-2% to taste;
(d) sweetener 0-5% to taste;
(e) peanut butter stabilizer 0-4%;
(f) nut granules 0-20%; and
(g) a remaining portion, with the combination of all ingredients and the remaining portion having a fat content of 42-54% total fat, consisting of peanut flour and/or reduced fat peanut paste, and optionally additional peanut paste.

13. The enhanced peanut butter of claim 12, containing a sweetener wherein the sweetener is selected from the group consisting of sugar, molasses, and evaporated cane juice.

14. The enhanced peanut butter of claim 12, containing a stabilizer further defined as a stabilized peanut butter manufactured without the use of a processing step such as a scraped walled heat exchanger that results in a rapid cooling and formation of fine crystals.

15. The enhanced peanut butter of claim 12, containing long chain omega-3 wherein the long chain omega-3 fatty acids are unencapsulated.

16. The enhanced peanut butter of claim 12, further comprising high oleic peanuts.

17. An enhanced almond butter product comprising:
(a) 3-44% unhydrogenated oil (1-14 g/serving) selected from the group consisting of canola or olive oil;
(b) 0-1000 mg long chain omega-3 fatty acids (EPA/DHA) per 32 g serving;
(c) salt 0-2% to taste;
(d) sweetener 0-5% to taste;
(e) stabilizer 0-4%.
(f) a remaining portion, with the combination of all ingredients and the remaining portion having a fat content of 42-54% total fat, consisting of almond flour and/or reduced fat almond paste, and optionally additional almond paste.

18. A label for the enhanced nut butter product of claim 1, wherein a health claim is made on the label that cannot be made on an unenhanced nut butter product.

19. The label of claim 18 wherein the label of the product contains a health claim related to heart health.
